(19) United States
(12) Patent Application Publication
(10) Pub. No.: US 2006/0041334 A1
(43) Pub. Date: Feb. 23, 2006

(54) Toxic chemical substrate management systems and methods

(75) Inventors: Ching-Hui Chen, Kaohsiung City (TW); Chi-Bing Liu, Hsinchu City (TW); Chih-Liang Wang, Changhua County (TW); Ching-Lung Cheng, Hsinchu County (TW)

Correspondence Address: BIRCH STEWART KOLASCH & BIRCH, PO BOX 747, FALLS CHURCH, VA, 22040-0747, US

(73) Assignee: Powerchip Seminconductor Corp.

(21) Appl. No.: 11/099,575

(22) Filed: Apr. 6, 2005

(30) Foreign Application Priority Data
Aug. 20, 2004 (TW) 93125109

(51) Int. Cl. G05D 29/00

(52) U.S. Cl. 700/266

(57) ABSTRACT

Toxic chemical substrate management systems for use in a factory having a material management system are disclosed. The toxic chemical substrate management system includes at least a server, a processing unit and a database. The server is coupled to the material management system to receive toxic chemical substrate information, comprising identification to be stored in the database. The server receives an instruction, and the processing unit manages operations of the toxic chemical substrate according to the identification and the instruction. The operations include request, use, storage and return of the toxic chemical substrate. The toxic chemical substrate management system further provides interfaces to query the stock, use volume, operating amount, type of the toxic chemical substrate, and suppliers and operating region thereof.

### BACKGROUND

The present disclosure relates generally to material management, and more particularly, to systems and methods of managing toxic chemical substrates in factories.

Specific toxic chemical substrates may be used for fabricating products. For example, toxic gases which pollute the environment or damage humans may be used in semiconductor manufacturing. The management and monitoring of toxic chemical substrates is an important issue for product manufacturing and environmental protection.

In semiconductor manufacturing, for example, a foundry may have several factory areas. Toxic chemical substrates may be dispersed in production lines, chemical rooms, or gas cabinets of respective factory areas, and used independently. Conventionally, toxic chemical substrates are managed manually. After receiving demand orders from a foundry, a supplier delivers toxic chemical substrates to a joint gas warehouse. Respective factory areas can acquire required toxic chemical substrates from the joint gas warehouse according to the required use thereof, and stock then in respective gas cabinets for further use. Conventionally, stocking and management of the toxic chemical substrates are performed manually, and with use thereof recorded and reported by related personnel of respective factory areas. Since no computerized management mechanism is provided, recording personnel and reporting of the use may be inconsistent, such that the amount of respective toxic chemical substrates is difficult to calculate, possibly causing failure of toxic chemical substrate management.

As described, since conventional management is performed manually, a steel cylinder storing respective toxic chemical substrates may be dispersed in respective factory areas, equipment, and gas cabinets, making effective and correct management of respective toxic chemical substrates impracticable. Further, the demand of foundries is determined based on reported use of the toxic chemical substrates, if management thereof is incorrect, production costs whereby may increase, along with risk and damage to the environment and personnel.

### SUMMARY

Toxic chemical substrate management systems and methods are provided. In an exemplary embodiment of a toxic chemical substrate management system for use in a factory having a material management system, the toxic chemical substrate management system comprises a server, a processing unit and a database. The server is coupled to the material management system to receive toxic chemical substrate information, comprising identification to be stored in the database. The server receives an instruction, and the processing unit manages operations of the toxic chemical substrate according to the identification and the instruction. The operations include request, use, storage and return of the toxic chemical substrate. The database couples to the server and processing unit for storing the toxic chemical substrate information.

The server further receives the use of the toxic chemical substrate. Such use is monitored by a monitor system coupled to the storage region of the toxic chemical substrate. The processing further registers the use.

The toxic chemical substrate management system provides a register interface for registering the operating condition of the toxic chemical substrate and the toxic chemical substrate information. The toxic chemical substrate management system further provides interfaces to query the stock, use volume, operating amount, type of toxic chemical substrate, and suppliers and operating region thereof.

The toxic chemical substrate management system further includes a toxic chemical substrate emergency system for recording dealing information, such as counter measures corresponding to the toxic chemical substrate. When an emergency occurs, the processing unit retrieves and displays the dealing information to assist dealing with the emergency.

The identification of the toxic chemical substrate is made according to the container corresponding to the toxic chemical substrate.

In an exemplary embodiment of a toxic chemical substrate management method, for use in a factory having a material management system, a toxic chemical substrate management system comprising a server, a processing unit and a database is provided. The server is coupled to the material management system. The material management system recognizes whether a substrate is a toxic chemical substrate. If so, the material management system generates toxic chemical substrate information corresponding to the toxic chemical substrate. The toxic chemical substrate information comprises identification. The server stores the toxic chemical substrate information in the database. The processing unit manages operations of the toxic chemical substrate according to the toxic chemical substrate information thereof.

The use of the toxic chemical substrate is further monitored via a monitor system coupled to the storage region of the toxic chemical substrate. The use is further reported and registered in the toxic chemical substrate management system. If the use is not reported from the monitor system, related personnel are notified by email messages or messenger calls for subsequent processing.

A toxic chemical substrate emergency system is further provided for providing dealing information, such as counter measures corresponding to the toxic chemical substrate. When an emergency occurs, the dealing information is displayed to assist dealing with the emergency.

At least one registration interface is further provided for registering the operating condition of the toxic chemical substrate and the toxic chemical substrate information. At least one query interface is further provided for querying the stock, use volume, operating amount, type of toxic chemical substrate, and suppliers and operating region thereof.

Toxic chemical substrate management methods may take the form of program code embodied in a tangible media. When the program code is loaded into and executed by a machine, the machine becomes an apparatus for practicing the disclosed method.

### DESCRIPTION OF THE DRAWINGS

Toxic chemical substrate management systems and methods will become more fully understood by referring to the following detailed description with reference to the accompanying drawings, wherein:

FIG. 1 is a schematic diagram illustrating the system architecture of a factory management system according to of an embodiment of the present invention;

FIG. 2 is a schematic diagram illustrating the system architecture of a database according to of an embodiment of the present invention;

FIG. 3 is a flowchart showing initiation management for toxic chemical substrates according to of an embodiment of the present invention;

FIG. 4 is a flowchart showing operation registration for toxic chemical substrates according to of an embodiment of the present invention;

FIG. 5 is a flowchart showing query for toxic chemical substrates according to of an embodiment of the present invention; and

FIG. 6 shows an example of a query interface.

### DESCRIPTION

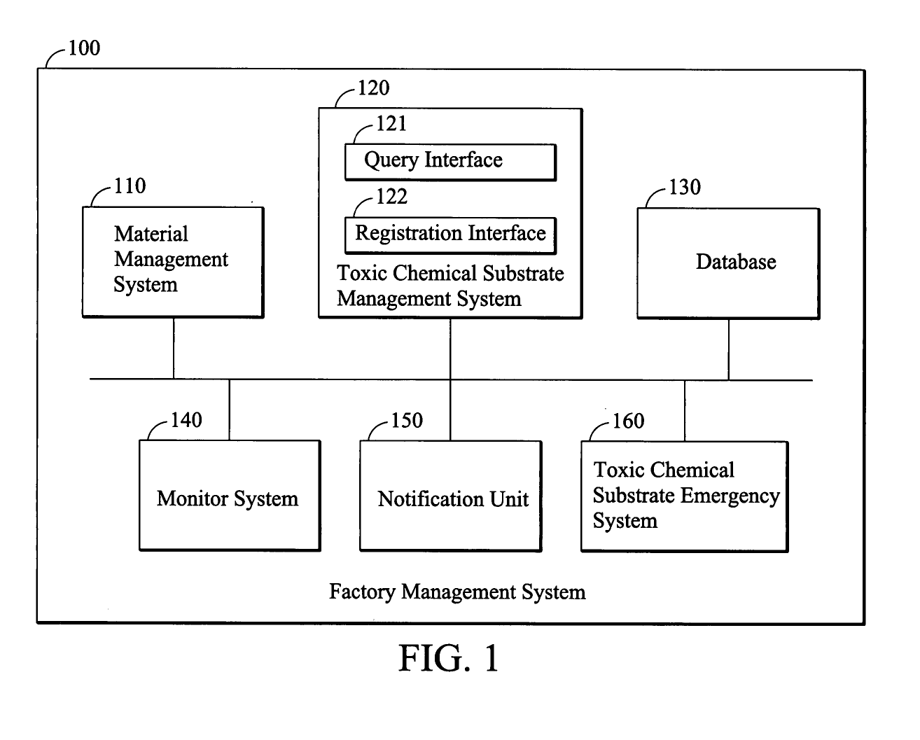

FIG. 1 is a schematic diagram illustrating the system architecture of a factory management system according to of an embodiment of the present invention. The factory management system 100 includes a material management system 110, a toxic chemical substrate management system 120, a database 130, a monitor system 140, a notification unit 150 and a toxic chemical substrate emergency system 160.

The material management system 110 manages normal materials of the factory. The material management system 110 generates identification of respective materials, and manages respective materials accordingly. In some embodiments of the present invention, the material management system 110 can be designed to recognize toxic chemical substrates to be monitored, and generate another identification corresponding to respective toxic chemical substrates or the container thereof. The identification is affixed on a container storing the toxic chemical substrates. The encoding manner of the identification can be determined according to the type and material number of respective toxic chemical substrates, the date entering the factory, and a serial number. For example, the material management system 110 can generate a tag recording a bar code for respective normal materials. If the material is a toxic chemical substrate, the material management system 110 further generates another identification corresponding to the toxic chemical substrate on the tag. Further, the material management system 110 automatically transmits the information of the toxic chemical substrate to the toxic chemical substrate management system 120. The information comprises the identification, volume, and supplier of the toxic chemical substrate. In some embodiments of the present invention, for accurately managing toxic chemical substrates, a toxic chemical substrate stored in different containers may have different identification.

The toxic chemical substrate management system 120 is a computerized system, and manages operations of respective toxic chemical substrates according to the identification thereof. The operations include request, use, storage and return of respective toxic chemical substrates. The toxic chemical substrate management system 120 provides online access to the system via networks. The toxic chemical substrate management system 120 comprises a server (not shown), a processing unit (not shown) and a database 130. The server is coupled to the components of the factory management system 100, such as the material management system 110 via networks to receive related information, such as the toxic chemical substrate information, and stores the information in the database 130. Additionally, the server receives instructions for managing respective toxic chemical substrates via networks. The processing unit can manage the operations of respective toxic chemical substrates according to the identification and the instructions.

The toxic chemical substrate management system 120 provides a registration interface 122. The monitor system 140 or related personnel can register the toxic chemical substrate information and the operating condition of respective toxic chemical substrates to the toxic chemical substrate management system 120, and store it in the database 130 via the registration interface 122. The toxic chemical substrate management system 120 further provides at least one query interface 121 for querying the stock, use volume, operating amount, type of respective toxic chemical substrates, and suppliers and operating region thereof. The query for the stock of a toxic chemical substrate traces the use of the toxic chemical substrate, such as operating condition and storage region of the toxic chemical substrate, and its associated factory area and/or department. The query for the use volume of a toxic chemical substrate traces the use volume of the toxic chemical substrate for respective factory areas and/or departments. The query for the operating amount of a toxic chemical substrate traces the use volume of the toxic chemical substrate for respective factory areas and/or departments in a unit, such as day, month or season. The query for the type of a toxic chemical substrate queries the type of the toxic chemical substrate used in respective factory areas and/or departments. The query for the supplier of a toxic chemical substrate is to query the name, contact person, phone number and operating license of the supplier providing the toxic chemical substrate. The query for the operating region of a toxic chemical substrate queries the location information of factory areas, equipment, and gas cabinets operating the toxic chemical substrate.

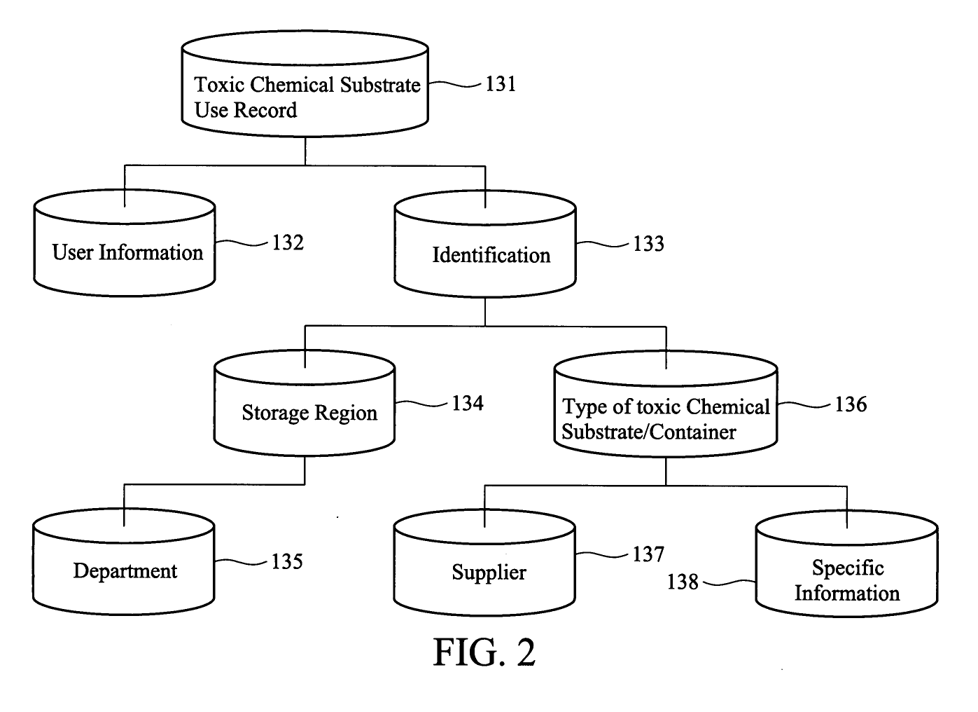

The database 130 records the operating condition of respective toxic chemical substrates and toxic chemical substrates information based on the instructions from the toxic chemical substrate management system 120, and provides related information for query. FIG. 2 is a schematic diagram illustrating the system architecture of a database according to of an embodiment of the present invention. As shown in FIG. 2, the database 130 records at least one toxic chemical substrate use record 131, user information 132, identification 133, storage region 134, department 135, type of toxic chemical substrate/container 136, supplier 137, and specific information 138, such as weight, pressure, and elements. It is understood that the database 130 may be in the toxic chemical substrate management system 120, or independent from the toxic chemical substrate management system 120.

The monitor system 140 couples to the storage region of respective toxic chemical substrates in respective factory areas. The monitor system 140 monitors the use of respective toxic chemical substrate, such as the pressure, use volume, and average use rate, and reports and registers it to the toxic chemical substrate management system 120. If the use is not reported from the monitor system 140 for a predetermined period, the notification unit 150 notifies related personnel by email messages or messenger calls for subsequent processing. It is understood that the notification may comprise the type, department, and storage region of the toxic chemical substrate not reported for speeding the securing the subsequent processes. Additionally, the toxic chemical substrate emergency system 160 is further coupled with the database 130 to provide dealing information, such as counter measures corresponding to respective toxic chemical substrates. When an emergency corresponding to a toxic chemical substrate occurs, the dealing information corresponding to the toxic chemical substrate is displayed to assist dealing with the emergency. In some embodiments of the present invention, since the toxic chemical substrate emergency system 160 is already existed in the factory, the toxic chemical substrate emergency system 160 and database 130 can be joined and connected. The dealing information corresponding to respective toxic chemical substrates, however, can be also established in the database 130, but is not limited thereto. The monitor system can be a general monitor system used in the factory. Additionally, the monitor system can be also included in the toxic chemical substrate management system 120. That is the toxic chemical substrate management system 120 can be used in a factory without a general monitor system.

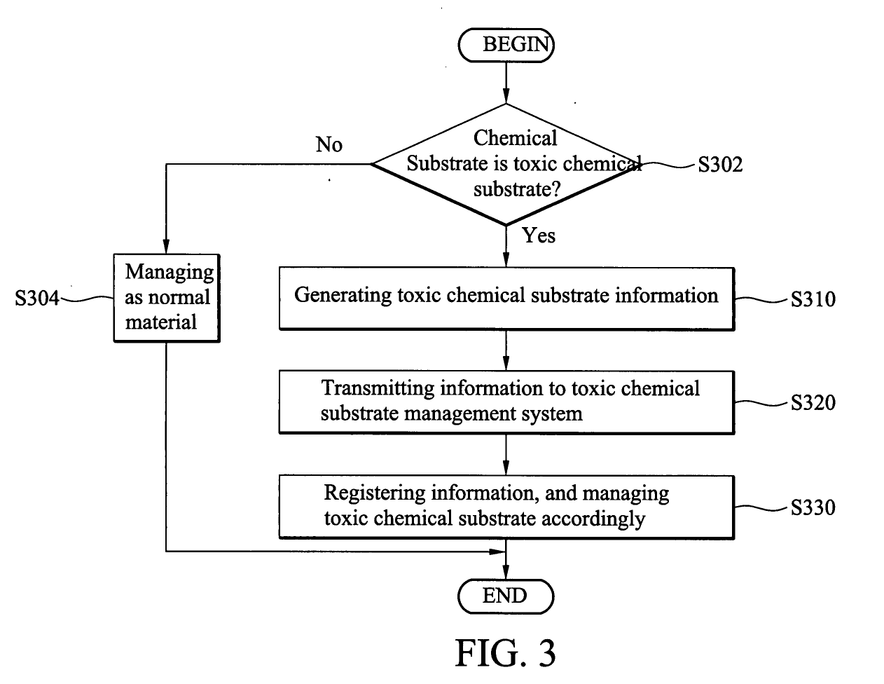

FIG. 3 is a flowchart showing initiation management for toxic chemical substrates according to an embodiment of the present invention.

When a chemical substrate enters the factory, in step S302, the material management system 110 determines whether the chemical substrate is a toxic chemical substrate to be monitored. If not, in step S304, the chemical substrate is a normal material and managed accordingly. If so, in step S310, the material management system 110 generates toxic chemical substrate information corresponding to the toxic chemical substrate or its container, and encodes the identification according to the type and material number of the toxic chemical substrate, and the date entering the factory, such that the toxic chemical substrate or its container has a unique identification. Then, in step S320, the material management system 110 transmits the information to the toxic chemical substrate management system 120. In step S330, the toxic chemical substrate management system 120 registers the information and manages operations of the toxic chemical substrate according to the identification thereof.

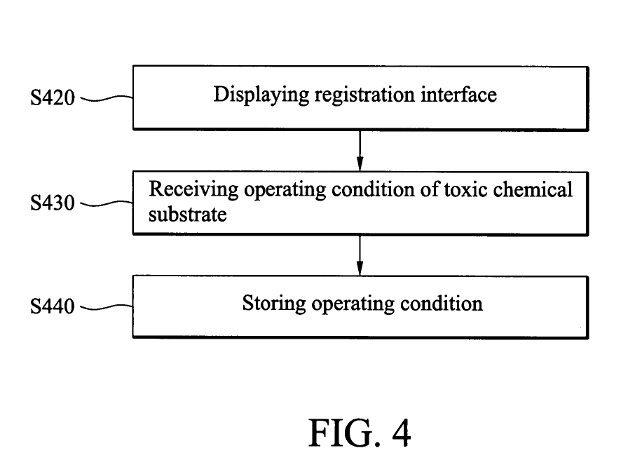

FIG. 4 is a flowchart showing operation registration for toxic chemical substrates according to an embodiment of the present invention.

First, in step S420, the registration interface is displayed. It is understood that since the operations may include request, use, storage and return of respective toxic chemical substrates, the registration interface may comprise several sub-interfaces for different operation registrations. In steps S430 and S440, the operating condition of respective toxic chemical substrates is received, and stored in the database 130. The registration (S420˜S440) can be continuously performed until the system is suspended. It is understood that the monitor system 140 can automatically monitor and register the use of respective toxic chemical substrates, such as the pressure, use volume, and average use rate. If the monitor system 140 cannot automatically perform the registration, the registration can be performed by related personnel via the registration interface.

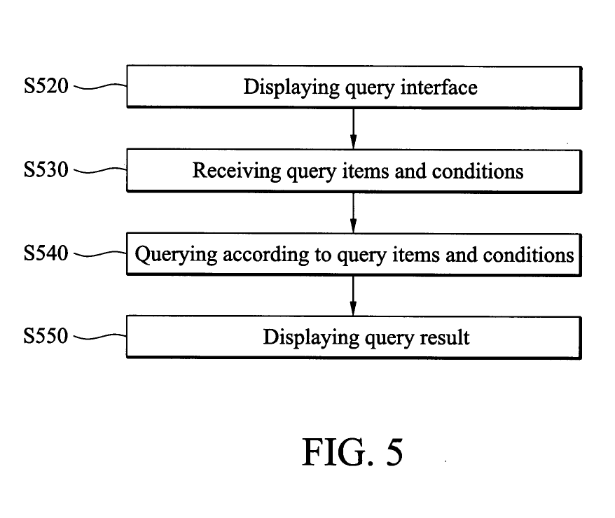

FIG. 5 is a flowchart showing query for toxic chemical substrates according to an embodiment of the present invention.

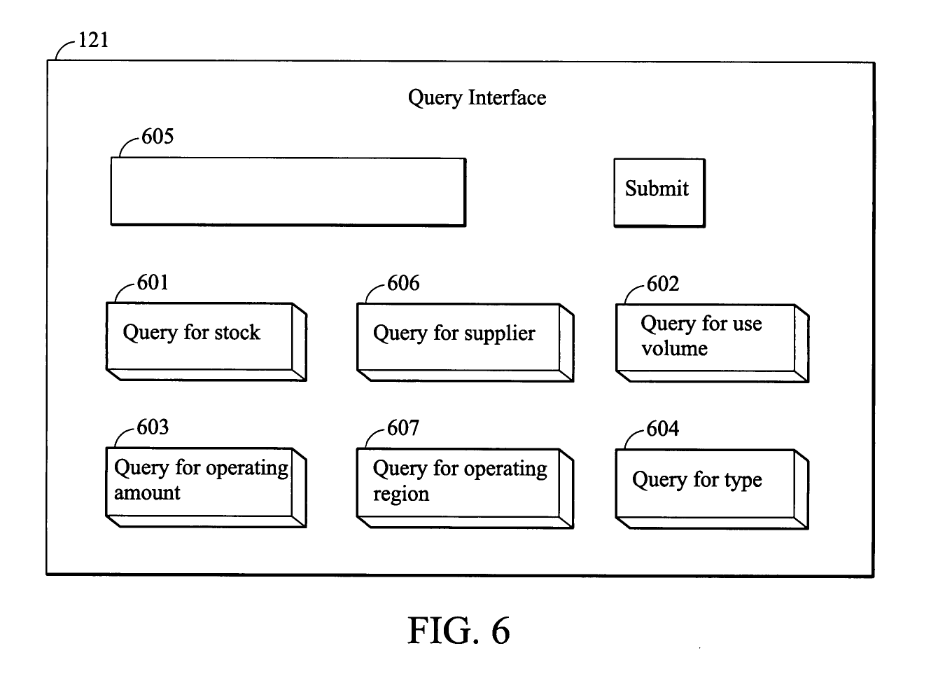

First, in step S520, a query interface 121 is displayed. Since various queries are provided in the system, the query interface 121 may display several query items, as shown in FIG. 6. The query interface 121 in FIG. 6 comprises several query manners (items): query for stock 601, query for use volume 602, query for operating amount 603, query for type 604, query for supplier 606, and query for operating region 607. Respective queries may have a corresponding input interface. Additionally, the query interface 121 provides a query field 605 for receiving query keywords and conditions in text form. Then, in step S530, query items and conditions, such as user information, identification, storage region, department, type of toxic chemical substrate, supplier, and toxic chemical substrate information are received via the query interface 121. In step S540, a query is performed according to the query items and conditions, and in step S550, the query result is displayed.

It is understood that the toxic chemical substrate management system 120 can set a minimum volume for respective toxic chemical substrates or corresponding containers, and notify related personnel about the toxic chemical substrates or containers under the minimum volume for requesting return to the gas warehouse. Additionally, the returned toxic chemical substrates or containers can be listed for disposal.

Toxic chemical substrate management methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A toxic chemical substrate management system, for use in a factory comprising a material management system, comprising:
a server receiving at least one instruction, coupled to the material management system to receive toxic chemical substrate information of a toxic chemical substrate, wherein the toxic chemical substrate information comprises identification;
a processing unit managing operations of the toxic chemical substrate according to the identification and the instruction, wherein the operations comprise request, use and storage of the toxic chemical substrate; and
a database coupled to the server and the processing unit, storing the toxic chemical substrate information.

2. The system of claim 1 wherein the server further receives use of the toxic chemical substrate, and the processing unit further registers the use in the database, wherein the use is monitored by a monitor system coupled to a storage region of the toxic chemical substrate.

3. The system of claim 1 further comprising:
a registration interface; and
a query interface.

4. The system of claim 3 wherein the query interface further comprises:
a first interface receiving a query for stock of the toxic chemical substrate;
a second interface receiving a query for use volume of the toxic chemical substrate;
a third interface receiving a query for operating amount of the toxic chemical substrate;
a fourth interface receiving a query for type of the toxic chemical substrate;
a fifth interface receiving a query for supplier of the toxic chemical substrate; and
a sixth interface receiving a query for operating region of the toxic chemical substrate.

5. The system of claim 1 further comprising a toxic chemical substrate emergency system recording dealing information corresponding to the toxic chemical substrate, in which when an emergency occurs, the processing unit retrieves and displays the dealing information to assist dealing with the emergency.

6. The system of claim 1 wherein the operations further comprise return of the toxic chemical substrate, such that when the toxic chemical substrate is under a predetermined volume, the identification is discarded.

7. The system of claim 1 wherein the identification of the toxic chemical substrate is determined according to a container corresponding to the toxic chemical substrate.

8. A toxic chemical substrate management method, for use in a factory having a material management system, comprising:
providing a toxic chemical substrate management system comprising a server, a processing unit and a database;
coupling the server to the material management system;
determining whether a substrate is a toxic chemical substrate by the material management system, and if so, generating toxic chemical substrate information corresponding to the toxic chemical substrate, wherein the toxic chemical substrate information comprises identification;
storing the toxic chemical substrate information in the database via the server; and
managing operations of the toxic chemical substrate according to the toxic chemical substrate information thereof by the processing unit.

9. The method of claim 8 further comprising monitoring and reporting use of the toxic chemical substrate to the toxic chemical substrate management system via a monitor system coupled to a storage region of the toxic chemical substrate.

10. The method of claim 9 further comprising:
receiving a query for stock of the toxic chemical substrate via a first interface;
receiving a query for use volume of the toxic chemical substrate via a second interface;
receiving a query for operating amount of the toxic chemical substrate via a third interface;
receiving a query for type of the toxic chemical substrate via a fourth interface;
receiving a query for supplier of the toxic chemical substrate via a fifth interface; and
receiving a query for operating region of the toxic chemical substrate via a sixth interface.

11. The method of claim 10 further comprising receiving a query for operating condition and storage region of the toxic chemical substrate and associated factory area via the first interface.

12. The method of claim 8 further comprising linking a toxic chemical substrate emergency system recording dealing information corresponding to the toxic chemical substrate to the database, in which when an emergency occurs, the processing unit retrieves and displays the dealing information to assist dealing with the emergency.

13. The method of claim 8 wherein the processing unit further manages the return of the toxic chemical substrate, such that when the toxic chemical substrate is under a predetermined volume, the identification is discarded.

14. The method of claim 1 further comprising affixing the identification on a container of the toxic chemical substrate after the substrate is determined to be the toxic chemical substrate.

15. A set of application program interfaces embodied on a computer-readable medium for execution on a computer in conjunction with an application program that performs toxic chemical substrate management, comprising:
a registration interface receiving an operating condition of a toxic chemical substrate, and registering the operating condition; and
a query interface, comprising:
a first interface receiving a query for stock of the toxic chemical substrate;
a second interface receiving a query for use volume of the toxic chemical substrate; and
a third interface receiving a query for operating amount of the toxic chemical substrate.

16. The set of application program interfaces of claim 15 wherein the query interface further comprises:
a fourth interface receiving a query for type of the toxic chemical substrate;
a fifth interface receiving a query for supplier of the toxic chemical substrate; and
a sixth interface receiving a query for operating region of the toxic chemical substrate.

17. A factory management systems, comprising:
a material management system determining at least one toxic chemical substrate, and generating toxic chemical substrate information corresponding to the toxic chemical substrate, wherein the toxic chemical substrate information comprises identification; and
a toxic chemical substrate management system coupled to the material management system, managing operations of the toxic chemical substrate according to the identification, wherein the operations comprise request, use and storage of the toxic chemical substrate.

18. The system of claim 17 further comprising a monitor system coupled to a storage region of the toxic chemical substrate, monitoring and reporting use of the toxic chemical substrate to the toxic chemical substrate management system.

19. The system of claim 17 wherein the toxic chemical substrate management system further comprises:
a registration interface receiving an operating condition of the toxic chemical substrate, and registering the operating condition; and
a query interface receiving a query for stock of the toxic chemical substrate, a query for use volume of the toxic chemical substrate, a query for operating amount of the toxic chemical substrate, a query for type of the toxic chemical substrate, a query for supplier of the toxic chemical substrate, and a query for operating region of the toxic chemical substrate.

20. The system of claim 17 further comprising a toxic chemical substrate emergency system for recording dealing information corresponding to the toxic chemical substrate.
